(19) United States
(12) Patent Application Publication
(10) Pub. No.: US 2008/0231876 A1
(43) Pub. Date: Sep. 25, 2008

(54) IMAGE PROCESSING APPARATUS

(75) Inventor: Hiroyuki Harada, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/042,400

(22) Filed: Mar. 5, 2008

(30) Foreign Application Priority Data
Mar. 19, 2007 (JP) 2007-071059

(51) Int. Cl. H04N 1/40

(52) U.S. Cl. 358/1.9; 345/173

(57) ABSTRACT

An image processing apparatus has a display to display color images and a storage to store color image data. A first preview controller causes the display to display a color preview image based on stored color image data. A character-area extractor extracts a character area from the stored color image data and a color-designation acceptor accepts a designated color newly set in the extracted character area. A second preview controller changes a color of the extracted character area extracted in the preview image to the accepted designated color, and causes a display of the changed preview image. A decision-instruction acceptor accepts an instruction to set the designated color. A color-change processor responds to the accepted instruction by the decision-instruction acceptor to change information representing a color of the stored color image data to allow the color of the extracted character area to be changed to the accepted designated color.

### BACKGROUND OF THE INVENTION

1. Field of the Invention

The present invention relates to an image processing apparatus for subjecting color image data including a character to an image processing.

2. Description of the Related Art

In recent years, it has become so popular to use a scanner apparatus designed to read a color image from a document so as to create an electronic file containing data about the color image, and transmit the electronic file to an external terminal unit, such as a personal computer, which is connected to the scanner apparatus via a network or a communication interface, and a complex machine having such a scanner function and a copy function.

With a view to reduction in communication load and in storage space required for storing image data in the form of an electronic file, the scanner apparatus or the complex machine is designed to compress color image data read from a document so as to reduce a file size.

As a methodology for efficiently compressing image data, there has been known an irreversible compression (i.e., lossy compression) scheme suitable for compression of a multivalued image, such as a JPEG (Joint Photographic Experts Group) scheme, which is configured to irreversibly compress image data while keeping deterioration in image quality at an invisible level by taking advantage of human's visual characteristics, so as to perform high-efficiency data compression.

In an operation of compressing image data consisting of a mixture of a character and a background image, using the irreversible compression scheme, there is a problem that severe deterioration in image quality occurs in an area having a high contract, such as a character area, to cause a decline in visibility of the character. In order to improve the problem about poor visibility of a character mixed with a multivalued image, the following technique has been known.

In this conventional technique, only a character area is extracted from a color image read from a document, and formed as monochrome (i.e., achromatic) binarized image data. The obtained binarized image data is compressed using an reversible compression scheme suitable for compression of binarized data, such as an MMR (Modified Modified Relative Element Address Designate) scheme. In addition, information about a specific color exhibiting a peak in a color histogram of the character area is acquired as color information of the character area. Image data about the remaining area other than the character area is compressed using the high-efficiency irreversible compression scheme.

That is, the above conventional technique is designed to compress image data about a character area and image data about a non-character area individually, and additionally acquire color information of the character area, so as to reduce a data volume without a decline in visibility of the character area (see, for example, JP 2002-77633A). There has also been known a file format, such as a high-compression PDF (Portable Document Format) or an XPS (XML Paper Specification) format, which is capable of combining the image data/color information of the character area and the image data about the remaining area other than the character area, and creating a single electronic file containing the combined data.

However, in cases where a specific color exhibiting a peak in a color histogram of a character area is used as a representative color of the character area as mentioned above, color reproducibility of a color character will deteriorate. This causes a problem that a color of the character area is likely to become different from a user's intended color due to the inability to express a delicate difference in hue, for example, in a color image where a vermilion seal is stamped beside a red character. Moreover, for example, in a color image where a color of a background image is similar to that of a character, there is a need for allowing a user to be able to change only the color of the character without changing the color of the background image.

### SUMMARY OF THE INVENTION

It is an object of the present invention to provide an image processing apparatus capable of allowing a user to set a color of a character area just as intended.

In order to achieve the above object, according to one aspect of the present invention, there is provided an image processing apparatus which comprises: a display section adapted to display a color image; a storage section adapted to store therein color image data; a first preview control section operable to cause the display section to display a color image based on the color image data stored in the storage section, in the form of a preview image; a character-area extraction section operable to extract a character area from the color image data stored in the storage section; a color-designation acceptance section operable to accept a setting of a designated color which is a color to be newly set in the character area extracted by the character-area extraction section; a second preview control section operable to change a color of the character area extracted by the character-area extraction section and included in the preview image, to the designated color accepted by the color-designation acceptance section, and cause the display section to display the changed preview image; a decision-instruction acceptance section operable to accept a decision instruction indicative of a decision to set the designated color; and a color-change processing section operable, in response to acceptance of the decision instruction by the decision-instruction acceptance section, to change color information representing a color of the color image data stored in the storage section, in such a manner as to allow the color of the character area extracted by the character-area extraction section, to be changed to the designated color accepted by the color-designation acceptance section.

In the above image processing apparatus, the first preview control section causes the display section to display a color image based on the color image data stored in the storage section, in the form of a preview image. This allows a user to figure out a color tone of the color image data stored in the storage section. Then, the character-area extraction section extracts a character area from the color image data stored in the storage section, and the color-designation acceptance section accepts a setting of a designated color which is a color to be newly set in the character area. Then, the second preview control section changes a color of the character area in the preview image, to the designated color, and causes the display section to display the changed preview image.

In response to acceptance of the decision instruction by the decision-instruction acceptance section, the color-change processing section changes color information representing a color of the color image data stored in the storage section, in such a manner as to allow the current color of the character area to be changed to the designated color. Thus, a user can set a new color to the character area, while checking the preview image to determine whether an intended image will be obtained. This makes it possible to allow a user to set a color of the character area in the color image data just as intended.

### BRIEF DESCRIPTION OF THE DRAWINGS

FIG. 1 is a block diagram showing the configuration of a scanner apparatus which is one example of an image processing apparatus, according to a first embodiment of the present invention.

FIG. 2 is a block diagram showing one example of the configuration of an intermediate-image processing section illustrated in FIG. 1.

FIG. 3 is an explanatory diagram showing a relationship between an L*a*b color coordinate system which represents a color difference value on a circle by an angle (i.e., hue angle) from zero degree to 360 degrees and a color saturation value by a distance from a center of the circle, and a preset color difference subrange corresponding to each of six colors: C (cyan), M (magenta), Y (yellow), R (red), G (green) and B (blue).

FIG. 4 is a block diagram showing one example of the configuration of a character-color changing processing section illustrated in FIG. 1.

FIG. 5 is an explanatory diagram showing one example of a color image of a document.

FIG. 6 is a schematic diagram for explaining an operation of the scanner apparatus illustrated in FIG. 1.

FIG. 7 is a flowchart showing one example of an operation of the intermediate-image processing section illustrated in FIG. 1.

FIG. 8 is a flowchart showing one example of an operation of the intermediate-image processing section illustrated in FIG. 1.

FIG. 9 is a schematic diagram for explaining a color-difference-subrange assigning processing.

FIG. 10 is a graph for explaining an operation of a histogram creation section illustrated in FIG. 2.

FIG. 11 is an explanatory diagram showing a state when a plurality of peaks are included in a histogram for one character area.

FIG. 12 is a graph for explaining a color-difference-subrange setting processing by a color-difference-subrange setup section illustrated in FIG. 2.

FIG. 13 is an explanatory diagram showing one example of a manual operation panel of the scanner apparatus.

FIG. 14 is a flowchart showing one example of an operation of the character-color changing processing section and associated sections.

FIG. 15 is a flowchart showing one example of an operation of a character-color changing processing section and associated sections in a scanner apparatus according to a second embodiment of the present invention.

FIG. 16 is a schematic diagram for explaining an operation of the character-color changing processing section in the scanner apparatus according to the second embodiment.

FIG. 17 is a block diagram showing one example of the configuration of a character-color changing processing section in a scanner apparatus according to a third embodiment of the present invention.

FIG. 18 is a flowchart showing one example of the operation of the character-color changing processing section and associated sections in the scanner apparatus according to the third embodiment.

FIG. 19 is a schematic diagram for explaining an operation of the character-color changing processing section in the scanner apparatus according to the third embodiment.

### DETAILED DESCRIPTION OF THE PREFERRED EMBODIMENTS

An embodiment of the present invention will now be described based on the drawings. In the figures, it denotes that two or more elements or components assigned with the same reference numerals or codes are identical to each other, and therefore a duplicate description about such elements or components will be omitted.

### First Embodiment

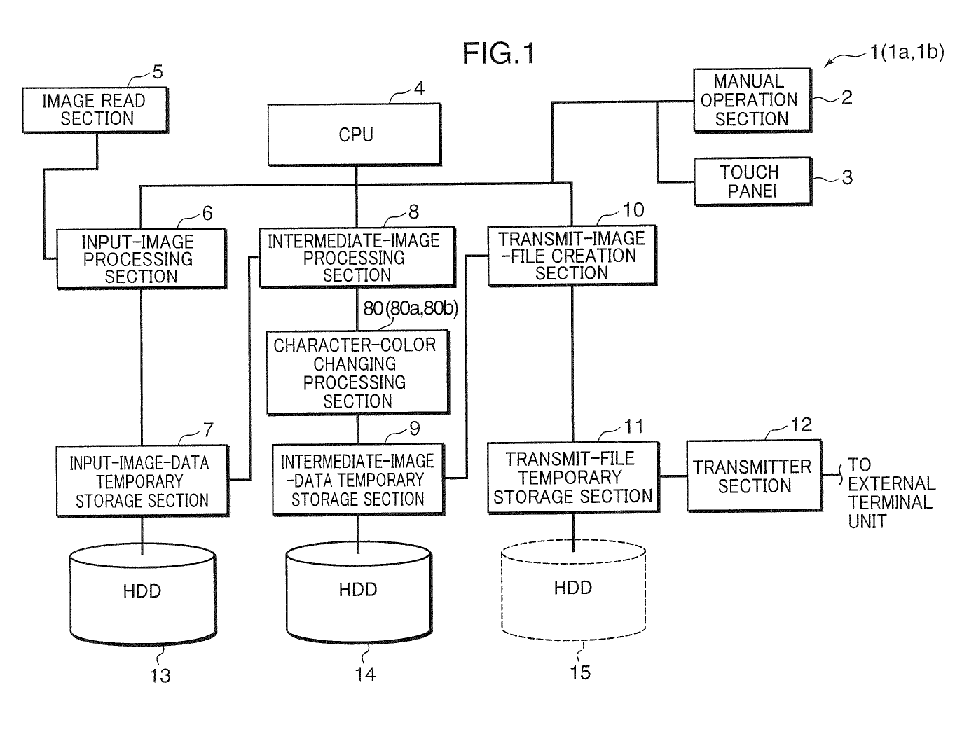

FIG. 1 is a block diagram showing the configuration of a scanner apparatus which is one example of an image processing apparatus, according to a first embodiment of the present invention. The scanner apparatus 1 illustrated in FIG. 1 comprises a manual operation section 2, a touch panel 3 (serving as a display section), a CPU (Central Processing Unit) 4, an image read section 5, an input-image processing section 6, an input-image-data temporary storage section 7, an intermediate-image processing section 8, a character-color changing processing section 80, an intermediate-image-data temporary storage section 9 (serving as a storage section), a transmit-image-file creation section 10 (serving as a combined-data creation section), a transmit-file temporary storage section 11, a transmitter section 12, and two HDDs (Hard Disk Drives) 13, 14. The image processing apparatus subject to the present invention may be a complex machine provided, for example, by adding an image forming section to the scanner apparatus 1 so as to additionally have a copy function.

The manual operation section 2 includes a manual operation key switch adapted to accept a user's operational instruction, or a communication interface circuit adapted to accept a user's operational instruction from an external terminal unit (not shown), such as a personal computer, which is connected to the scanner apparatus 1, via a network or an interconnection cable.

The touch panel 3 is composed, for example, of a liquid-crystal display panel having a transparent pressure-sensitive sensor provided on a surface thereof, and adapted to display variety of information and color images according to a control signal from the CPU 4, and, in response to a user's manual operation of pressing a certain position of a display screen thereof, output positional information representing the pressed position to the CPU 4.

The CPU 4 is operable to execute a control program stored in a ROM (Read Only Memory) or HDD (not shown) so as to control respective operations of the touch panel 3, the image read section 5, the input-image processing section 6, the input-image-data temporary storage section 7, the intermediate-image processing section 8, the intermediate-image-data temporary storage section 9, the transmit-file temporary storage section 11, the transmitter section 12, and the HDDs 13, 14, and function as the character-color changing processing section 80 and the transmit-image-file creation section 10, according to a user's operational instruction accepted through the manual operation section 2 and the touch panel 3.

Each of the input-image processing section 6 and the intermediate-image processing section 8 is composed, for example, of an ASIC (Application Specific Integrated Circuit). Each of the input-image-data temporary storage section 7, the intermediate-image-data temporary storage section 9 and the transmit-file temporary storage section 11 includes a temporary storage unit composed, for example, using a DRAM (Dynamic Random Access Memory). The HDDs 13, 14 may be a single HDD unit.

While each of the input-image processing section 6 and the intermediate-image processing section 8 in this embodiment is composed of a hardware circuit, such as an ASIC, the present invention is not limited to this configuration. For example, the CPU 4 may be configured to execute an image processing program stored in a ROM or HDD (not shown) so as to function as each of the input-image processing section 6 and the intermediate-image processing section 8.

For example, the scanner apparatus 1 may comprise an image read section 5, and a computer, such as a personal computer, which is connected to the image read section 5 via a communication cable or the like, and provided with the manual operation section 2, the touch panel 3, the CPU 4, the input-image processing section 6, the input-image-data temporary storage section 7, the intermediate-image processing section 8, the character-color changing processing section 80, the intermediate-image-data temporary storage section 9, the transmit-image-file creation section 10, the transmit-file temporary storage section 11, the transmitter section 12, and the HDDs 13, 14.

In this case, for example, the CPU 4 may be configured to execute an image processing program stored in a ROM or HDD (not shown) so as to function as each of the input-image processing section 6, the intermediate-image processing section 8, the character-color changing processing section 80 and the transmit-image-file creation section 10.

The image read section 5 includes an image scanner comprising a CCD (Charge Coupled Device). The image read section 5 is operable to read a color image of a document, and output a signal indicative of the color image to the input-image processing section 6, according to a control signal from the CPU 4. The input-image processing section 6 is operable to convert the signal output from the image read section 5 into a given data format so as to create data (hereinafter referred to as “input image data” or “document image data”) which expresses the color image of the document, for example, by three pixel values corresponding to respective colors: C (cyan), M (magenta) and Y (yellow), and store the document image data in the input-image-data temporary storage section 7. The CPU 4 may be configured to allow the document image data stored in the input-image-data temporary storage section 7 to be additionally stored in the HDD 13.

The intermediate-image processing section 8 is operable to subject the document image data stored in the input-image-data temporary storage section 7 to a given image processing so as to create color image data, and store the color image data in the intermediate-image-data temporary storage section 9. The character-color changing processing section 80 is operable to change a color of a character area in the color image data stored in the intermediate-image-data temporary storage section 9, according to a user's operational instruction. The CPU 4 may be configured to allow the color image data stored in the intermediate-image-data temporary storage section 9 to be additionally stored in the HDD 14.

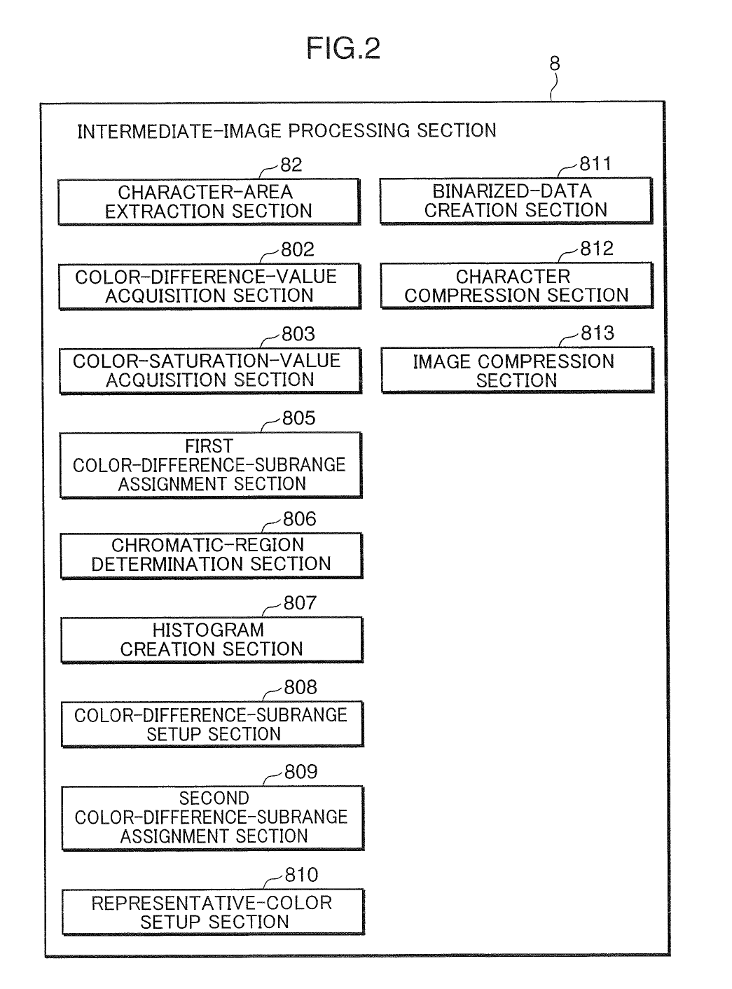

FIG. 2 is a block diagram showing one example of the configuration of the intermediate-image processing section 8. An intermediate-image processing section 8 illustrated in FIG. 2 comprises a character-area extraction section 82, a color-difference-value acquisition section 802, a color-saturation-value acquisition section 803, a first color-difference-subrange assignment section 805, a chromatic-region determination section 806, a histogram creation section 807, a color-difference-subrange setup section 808, a second color-difference-subrange assignment section 809, a representative-color setup section 810, a binarized-data creation section 811, a character compression section 812 and an image compression section 813.

The character-area extraction section 82 is operable to extract one or more character areas separated by a character or by a group of characters located within a given region, from the document image data stored in the input-image-data temporary storage section 7, in a conventional manner. The character-area extraction section 82 is also operable to store image data remaining after eliminating (i.e., extracting) the character areas from the document image data stored in the input-image-data temporary storage section 7, in the intermediate-image-data temporary storage section 9 in the form of multivalued image data.

The color-difference-value acquisition section 802 is operable to calculate a color difference value (i.e., hue angle) of each pixel in each of the character areas (e.g., in each character) extracted by the character-area extraction section 82. Specifically, the color-difference-value acquisition section 802 is operable to read out pixels in each of the character areas, from the document image data stored in the input-image-data temporary storage section 7, and compare C, M and Y pixel values with respect to each of the pixels. Then, the color-difference-value acquisition section 802 is operable, when a smallest one of the pixel values is the C pixel value, the M pixel value, and the Y pixel value, to calculate a color difference value HUE of each of the pixels, according to the following formula (1), the following formula (2), and the following formula (3), respectively:

$$\begin{matrix}HUE = 60 ° + \frac{( Y - M ) \times 60 °}{\vert Y - M \vert} & ( 1 ) \\ HUE = 180 ° - \frac{( C - Y ) \times 60 °}{\vert C - Y \vert} & ( 2 ) \\ HUE = 300 ° + \frac{( M - C ) \times 60 °}{\vert M - C \vert} & ( 3 )\end{matrix}$$

The color-saturation-value acquisition section 803 is operable to calculate a color saturation value SAT of each pixel in each of the character areas extracted by the character-area extraction section 82. Specifically, the color-saturation-value acquisition section 803 is operable to read out pixels in each of the character areas, from the document image data stored in the input-image-data temporary storage section 7, and calculate a color saturation value SAT with respect to each of the pixels, according to the following formula (4):

$$S A T = \frac{( MAX ( C , M , Y ) - MIN ( C , M , Y ) ) \times 360 °}{MAX ( C , M , Y )} \qquad ( 4 )$$

, wherein MAX (C, M, Y) represents a maximum one of the C, M and Y pixel values, and MIN (C, M, Y) represents a minimum one of the C, M and Y pixel values.

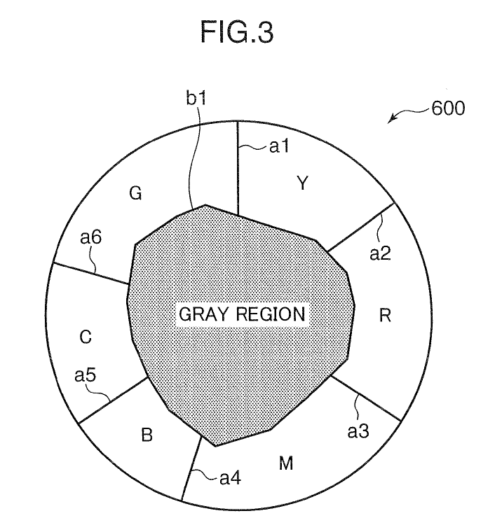

FIG. 3 is an explanatory diagram showing a relationship between an L*a*b color coordinate system which represents a color difference value on a circle by an angle (i.e., hue angle) from zero degree to 360 degrees and a color saturation value by a distance from a center of the circle, and a color difference subrange corresponding to each of six colors: C (cyan), M (magenta), Y (yellow), R (red), G (green) and B (blue), which is pre-stored, for example, in the HDD 13.

The L*a*b color coordinate system 600 illustrated in FIG. 3 is delimited by six boundary values a1, a2, a3, a4, a5, a6. The HDD 13 pre-stores: a range of the boundary value a1 to less than the boundary value a2, which serves as a color difference subrange (i.e., hue angle range) corresponding to Y (yellow); a range of the boundary value a2 to less than the boundary value a3, which serves as a color difference subrange corresponding to R (red); a range of the boundary value a3 to less than the boundary value a4, which serves as a color difference subrange corresponding to M (magenta); a range of the boundary value a4 to less than the boundary value a5, which serves as a color difference subrange corresponding to B (blue); a range of the boundary value a5 to less than the boundary value a6, which serves as a color difference subrange corresponding to C (cyan); and a range of the boundary value a6 to less than the boundary value a1, which serves as a color difference subrange corresponding to G (green). The HDD further pre-stores a gray-region determination threshold b1 for determining whether each pixel is a gray region.

The first color-difference-subrange assignment section 805 is operable to read out the color difference subranges corresponding to the respective colors: C (cyan), M (magenta), Y (yellow), R (red), G (green) and B (blue), from the HDD 13, and assign any one of the color difference subranges corresponding to the respective colors: C (cyan), M (magenta), Y (yellow), R (red), G (green) and B (blue), to each of the character areas, based on the read-out color difference subranges, and information about the pixel color difference values calculated for each of the character areas by the color-difference-value acquisition section 802.

With respect to the character areas assigned with the respective color difference subranges by the first color-difference-subrange assignment section 805, the chromatic-region determination section 806 is operable, based on information about the pixel color saturation values calculated for each of the character areas by the color-saturation-value acquisition section 803, to determine whether each of the character areas is a gray region, in such a manner that, if an overall color saturation value in a specific one of the character areas, e.g., an average of the color saturation values of the pixels included in a specific one of the character areas, is less than the gray-region determination threshold b1 stored in the HDD 13, the specific character area is determined as the gray region, and assign Bk (Black) to the character area determined as the gray region. In this case, each of the remaining character areas other than the character area determined as the gray region will be determined as a chromatic region.

The histogram creation section 807 is operable, based on information about the pixel color difference values calculated by the color-difference-value acquisition section 802 with respect to each of the character areas determined as the chromatic region, to create a histogram which represents an occurrence rate (e.g. the number) of pixels relative to a color difference value in the color difference subrange assigned to each of the character areas.

The color-difference-subrange setup section 808 is operable, when a plurality of peaks are included in one histogram created by the histogram creation section 807, to set a plurality of new color difference subranges in such a manner as to allow each of the new color difference subranges to include a respective one of the peaks.

The second color-difference-subrange assignment section 809 is operable, based on information about the color difference values of the pixels in a specific one of the character areas which includes a plurality of peaks, e.g., an average of the color difference values of the pixels in the specific character area, to re-assign one of the plurality of new color difference subranges set by the color-difference-subrange setup section 808, to the specific character area.

The representative-color setup section 810 is operable to set color information about a representative color of each of the character areas. For example, the color information is an average of the color-difference values of pixels included in the color-difference subrange assigned to the character area in the chromatic region (i.e., each of the remaining character areas other than the character area determined as the gray region by the chromatic-region determination section 806). And the representative-color setup section 810 store the color information about the representative color in the intermediate-image-data temporary storage section 9.

The binarized-data creation section 811 is operable to binarize image data about the character areas extracted by the character-area extraction section 82 so as to create character image data, and store the character image data in the intermediate-image-data temporary storage section 9. The character compression section 812 is operable to compress the character image data stored in the intermediate-image-data temporary storage section 9 so as to create compressed character image data, for example, using a reversible MMR scheme, and store the compressed character image data in the intermediate-image-data temporary storage section 9.

The image compression section 813 is operable to compress remaining image data other than the character areas in the document image data stored in the input-image-data temporary storage section 7, so as to create compressed image data, for example, using an irreversible JPEG scheme having a high data compression ratio, and store the compressed image data in the intermediate-image-data temporary storage section 9. The CPU 4 may be configured to allow the document image data stored in the intermediate-image-data temporary storage section 9, to be additionally stored in the HDD 14.

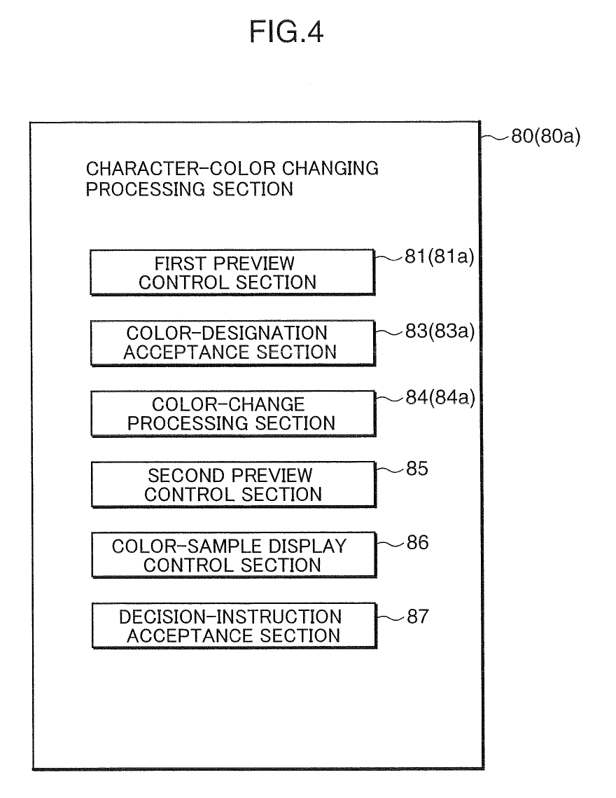

FIG. 4 is a block diagram showing one example of the configuration of the character-color changing processing section 80 illustrated in FIG. 1. A character-color changing processing section 80 illustrated in FIG. 4 comprises a first preview control section 81, a color-designation acceptance section 83, a color-change processing section 84 (serving as a color-information creation section), a second preview control section 85, a color-sample display control section 86, and a decision-instruction acceptance section 87.

The first preview control section 81 is operable to cause the touch panel 3 to display a preview image of the document, based on the color image data comprising the multivalued image data, the character image data and the color information which are stored in the intermediate-image-data temporary storage section 9. The first preview control section 81 is operable to cause the touch panel 3 to further display a plurality of optional colors for color selection.

The color-designation acceptance section 83 is operable, when the positional information output from the touch panel 3 represents a specific one of the character areas extracted by the character-area extraction section 82, to select the specific character area as a target character area, and, when the positional information output from the touch panel 3 represents a specific one of the plurality of optional colors, to accept the specific color as a designated color.

The second preview control section 85 is operable to change a color of the target character area in the preview image displayed on the touch panel 3, to the designated color accepted by the color-designation acceptance section 83. The color-sample display control section 86 is operable to cause the touch panel 3 to display a color of the character area selected as the target character area by the color-designation acceptance section 83, and a color accepted as the designated color by the color-designation acceptance section 83, side by side in a comparable manner.

The decision-instruction acceptance section 87 is operable to accept a decision instruction indicative of a decision to set the character area selected as the target character area by the color-designation acceptance section 83, and the color accepted as the designated color by the color-designation acceptance section 83.

The color-change processing section 84 is operable to change the color information stored in the intermediate-image-data temporary storage section 9 in such a manner as to allow a color of the character area selected as the target character area by the color-designation acceptance section 83, to be changed to a color accepted as the designated color by the color-designation acceptance section 83.

Returning to FIG. 1, the transmit-image-file creation section 10 is operable to combine the color image data comprising the color information, the compressed character image data and the compressed image data which are stored in the intermediate-image-data temporary storage section 9, together, so as to create an electronic file, such as a high-compression PDF (Portable Document Format) file or an XPS (XML Paper Specification) file, and store the electronic file in the transmit-file temporary storage section 11.

The transmitter section 12 is connected to an external terminal unit, such as a personal computer, via a LAN (Local Area Network) or cable (not shown). The transmitter section 12 includes a communication interface circuit adapted to transmit the electronic file stored in the transmit-file temporary storage section 11, to the external terminal unit. The scanner apparatus 1 may further include a HDD 15. In this case, the CPU 4 may be configured to allow the electronic file stored in the transmit-file temporary storage section 11, to be additionally stored to the HDD 15.

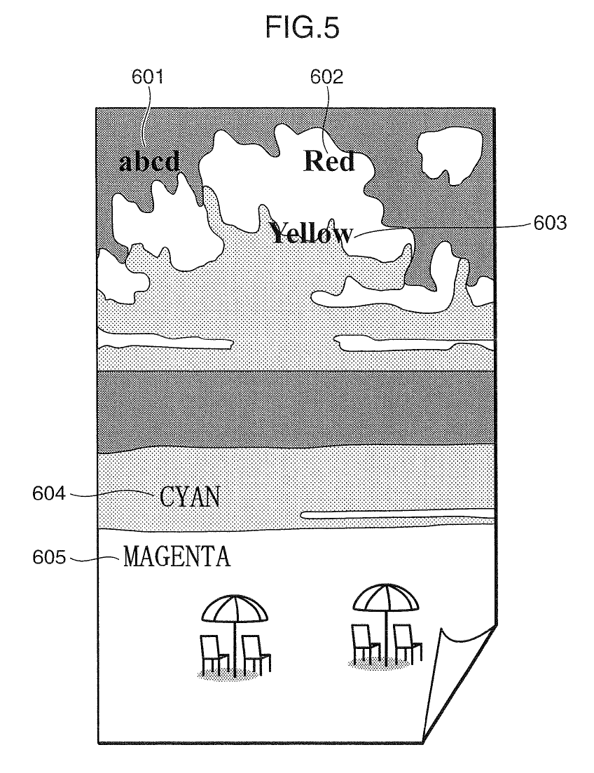

An operation of the scanner apparatus 1 configured as above will be described below. FIG. 5 is an explanatory diagram showing one example of a color image of a document. The color document image illustrated in FIG. 5 has a background color image, and a plurality of characters consisting of a black character 601, a red character 602, a yellow character 603, a cyan character 604 and a magenta character 605 which are superimposed on the background color image.

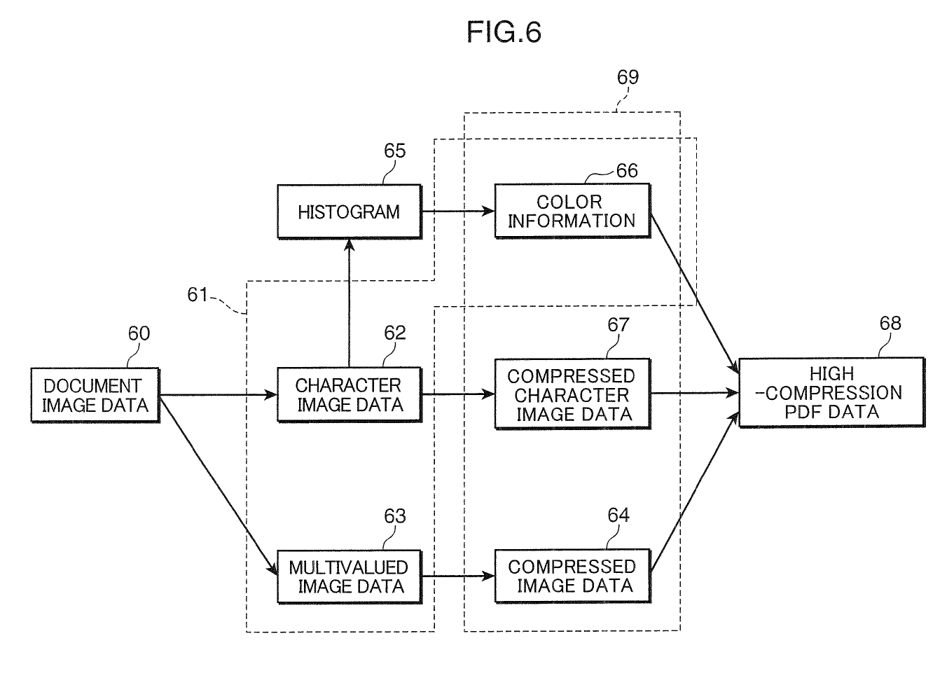

FIG. 6 is a schematic diagram for explaining an operation of the scanner apparatus 1. Upon acceptance of a user's operational instruction through the manual operation section 2, according to a control signal from the CPU 4, the image read section 5 reads the color document image, and outputs a signal indicative of the read image to the input-image processing section 6. Then, based on the signal output from the image read section 5, the input-image processing section 6 creates document image data 60 (document color image data) which expresses the color document image, for example, by three pixel values corresponding to respective colors: C (cyan), M (magenta) and Y (yellow), and store the document image data 60 in the input-image-data temporary storage section 7.

Then, the intermediate-image processing section 8 subjects the document image data 60 stored in the input-image-data temporary storage section 7 to a given image processing so as to create color image data 61 and intermediate image data 69, and stores the color image data 61 and the intermediate image data 69 in the intermediate-image-data temporary storage section 9.

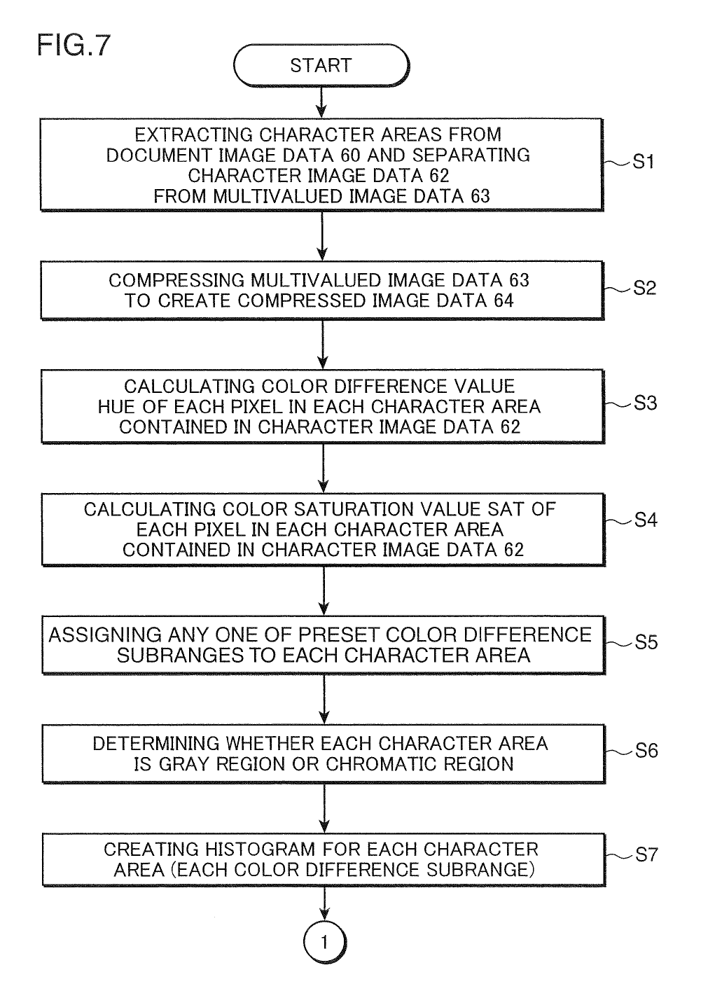

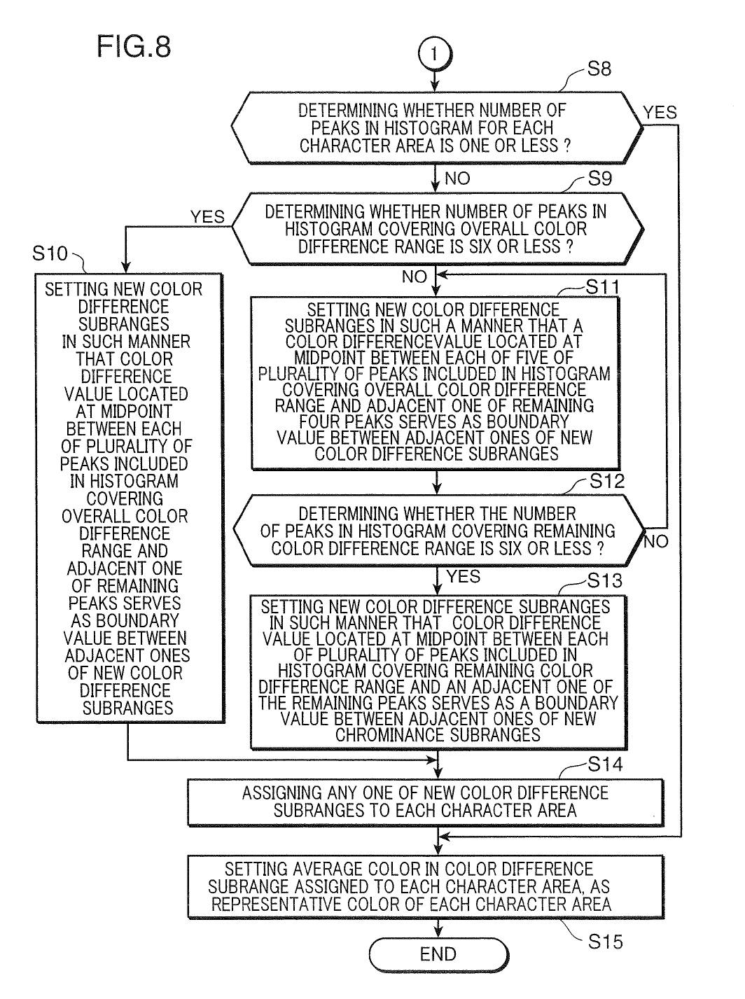

FIGS. 7 and 8 are flowcharts showing one example of an operation of the intermediate-image processing section 8. In the following description, it denotes that two or more steps assigned with the same step numbers are operationally identical to each other. In Step S1, the character-area extraction section 82 extracts one or more character areas from the document image data 60 stored in the input-image-data temporary storage section 7, and then the binarized-data creation section 811 binarizes image data about the character areas to create character image data 62, and stores the character image data 62 in the intermediate-image-data temporary storage section 9.

For example, the character image data 62 is created to contain a plurality of character areas which are separated from each other by a character. The character-area extraction section 82 also extracts the remaining image data other than the character areas, from the document image data 60, and stores the remaining image data in the intermediate-image-data temporary storage section 9 in the form of multivalued image data 63.

Then, the image compression section 813 compresses the multivalued image data 63 stored in the intermediate-image-data temporary storage section 9 to create compressed image data 64, for example, using a JPEG scheme, and stores the compressed image data 64 in the intermediate-image-data temporary storage section 9 (Step S2).

Then, the color-difference-value acquisition section 802 calculates a color difference value (i.e., hue angle) of each pixel in each of the character areas contained in the character image data 62 (Step S3). Specifically, the color-difference-value acquisition section 802 reads out pixels in each of the character areas, from the color image data 62, and compares C, M and Y pixel values with respect to each of the pixels.

Then, when a smallest one of the pixel values is the C pixel value, the M pixel value, and the Y pixel value, the color-difference-value acquisition section 802 calculates a color difference value HUE of each of the pixels, according to the aforementioned formula (1), the aforementioned formula (2), and the aforementioned formula (3), respectively.

Then, the color-saturation-value acquisition section 803 calculates a color saturation value SAT of each pixel in each of the character areas extracted by the character-area extraction section 82. Specifically, the color-saturation-value acquisition section 803 reads out pixels in each of the character areas, from the character image data 62, and calculates a color saturation value SAT with respect to each of the pixels, according to the aforementioned formula (4) (Step S4).

Then, the first color-difference-subrange assignment section 805 reads out the color difference subranges corresponding to the respective colors: C (cyan), M (magenta), Y (yellow), R (red), G (green) and B (blue), from the HDD 13. Subsequently, based on information about the pixel color difference values calculated for each of the character areas by the color-difference-value acquisition section 802, the first color-difference-subrange assignment section 805 assigns any one of the read-out color difference subranges to each of the character areas, for example, in such a manner as to allow an average of the color difference values of the pixels in each of the character areas to be included in the color difference subrange which is to be assigned to the character areas (Step S5).

Then, based on information about the pixel color saturation values calculated for each of the character areas by the color-saturation-value acquisition section 803, the chromatic-region determination section 806 determines whether each of the character areas is a gray region, in such a manner that, if an overall color saturation value in a specific one of the character areas, e.g., an average of the color saturation values of the pixels included in a specific one of the character areas, is less than the gray-region determination threshold b1 stored in the HDD 13, the specific character area is determined as the gray region, and assigns Bk (Black) to the character area determined as the gray region, so that each of the remaining character areas other than the character area determined as the gray region is determined as a chromatic region (Step S6).

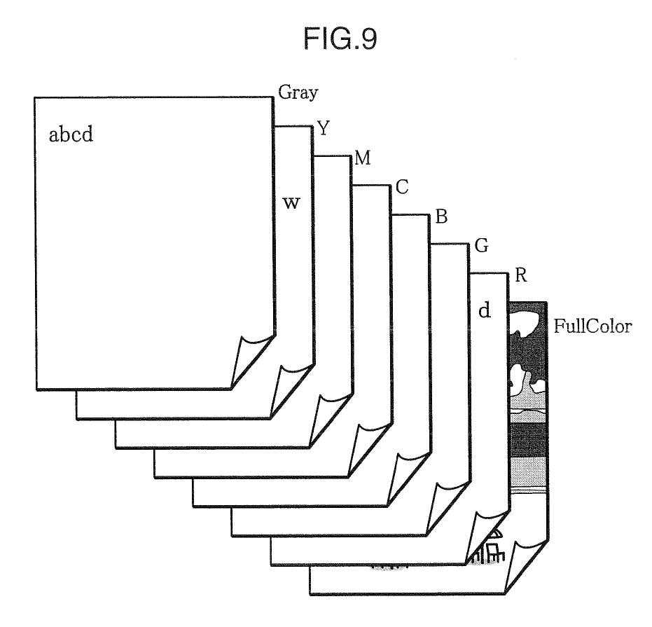

Through the above processing in Steps S5 and S6, for example, the black character 601, the yellow character 603, the magenta character 605, the cyan character 604 and the red character 602 in the document image illustrated in FIG. 5 are sorted into Gray, Y (yellow), M (magenta), C (cyan) and R (red), respectively, as shown in FIG. 9.

Then, based on information about the pixel color difference values calculated by the color-difference-value acquisition section 802, the histogram creation section 807 creates a histogram for each of the character areas, wherein the histogram represents an occurrence rate of pixels relative to a color difference value in each of the color difference subranges assigned to the respective character areas determined as the chromatic region (Step S7).

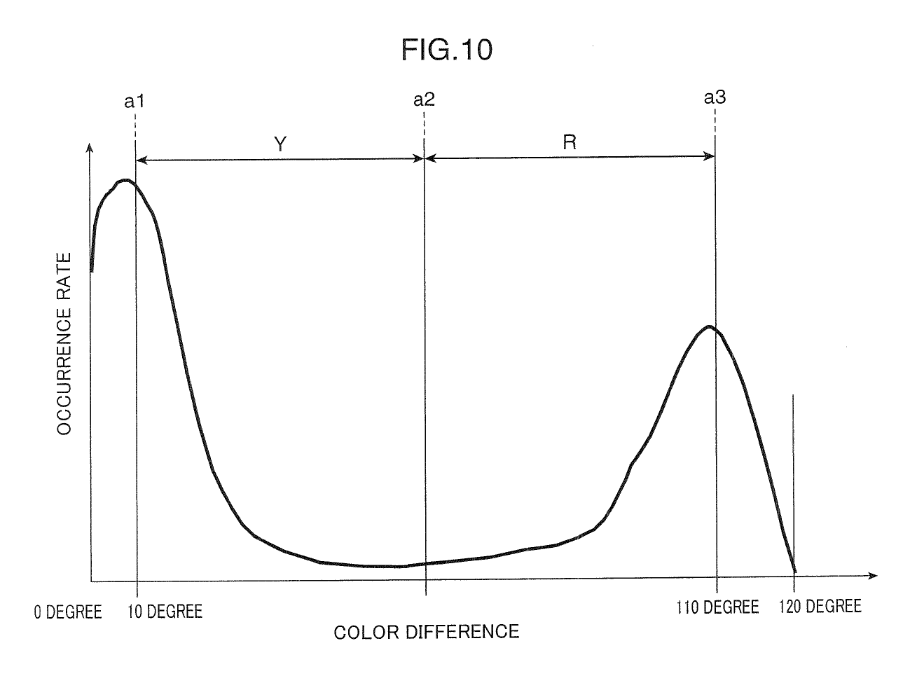

FIG. 10 is a graph for explaining an operation of the histogram creation section 807. In the histogram illustrated in FIG. 10, the horizontal axis represents a color difference value, and the vertical axis represents an occurrence rate of pixels relative to the color difference value on the horizontal axis, wherein the color difference value is in the subrange of zero degree to 120 degrees.

For example, when a color difference subrange assigned to a target one of the character areas is a Y color difference subrange (i.e., color difference subrange corresponding to Y (yellow)), the histogram creation section 807 is operable to read out the boundary values a1, a2 stored in the HDD 13 as the Y color difference subrange, and create a histogram covering the subrange of the boundary value a1 to the boundary value a2, as shown in FIG. 10. In the same manner, for example, when a color difference subrange assigned to a target one of the character areas is a R color difference subrange (i.e., color difference subrange corresponding to R (red)), the histogram creation section 807 is operable to read out the boundary values a2, a3 stored in the HDD 13, and create a histogram covering the subrange of the boundary value a2 to the boundary value a3.

Then, when a plurality of peaks are included in a histogram created for each of the character areas by the histogram creation section 807, the color-difference-subrange setup section 808 newly sets a plurality of color difference subranges in such a manner that each of the plurality of color difference subranges includes a respective one of the plurality of peaks.

Specifically, the color-difference-subrange setup section 808 determines whether the number of peaks included in a histogram for each of the character areas is one or less (Step S8). If the number of peaks is one or less (YES in Step S8), there is no need to change the color difference subrange, and thereby the routine will skip to Step S15 to set the color information about a representative color for each of the character areas. When the number of peaks is two or more (NO in Step S8), the routine advances to Step S9 to re-set all color difference subranges defined by dividing an overall color difference range (zero degree to 360 degrees).

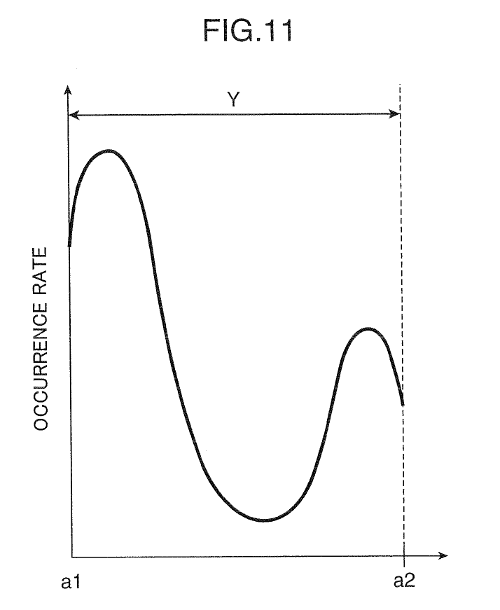

FIG. 11 is an explanatory diagram showing a state when a plurality of peaks are included in a histogram for a certain one of the character areas. For example, when a color difference subrange assigned to a target one of the character areas is the Y (yellow) color difference subrange, the histogram creation section 807 is operable to read out the boundary values a1, a2 stored in the HDD 13 as the Y color difference subrange, and create a histogram covering the subrange of the boundary value a1 to the boundary value a2.

The histogram covering the subrange of the boundary value a1 to the boundary value a2 is likely to have a plurality of peaks, e.g., two peaks, as shown in FIG. 11. If a representative color for the target character area is set using an average of the color saturation values which is calculated in the subrange of the boundary value a1 to the boundary value a2, a mixed color, i.e., a blend of plural colors, will be set as the representative color to cause the risk of deterioration in color reproducibility of a color character.

With a view to avoiding this problem, if the number of peaks is two or more (NO in Step S8), all the color difference subranges defined by dividing the overall color difference range (zero degree to 360 degrees) will be re-set to reduce the risk that a mixed color, i.e., a blend of plural colors, is set as a representative color of the target character area.

Specifically, in Step S9, the color-difference-subrange setup section 808 determines whether the number of peaks in a histogram covering the overall color difference range is equal to or less than a specific number (e.g., six or less), for example, which is determined in terms of processability by a hardware circuit (Step S9). When the number is six or less (YES in Step S9), the color-difference-subrange setup section 808 sets a plurality of new color difference subranges in such a manner that a color difference value located at a midpoint between each of the plurality of peaks included in the histogram covering the overall color difference range and an adjacent one of the remaining peaks serves as a boundary value between adjacent ones of the new color difference subranges (Step S10). Then, the routine advances to Step S14 to assign any one of the new color difference subranges to each of the character areas.

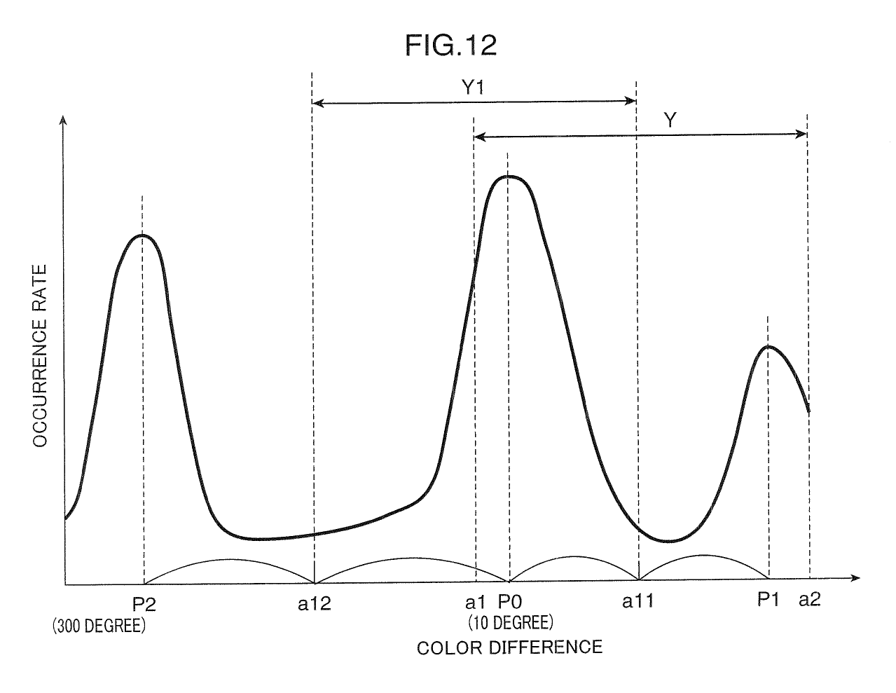

FIG. 12 is a graph for explaining a color-difference-subrange setting processing by the color-difference-subrange setup section 808. For example, when a target one of the character areas is assigned with the subrange of the boundary value a1 to boundary value a2 which is the Y (yellow) color difference subrange, and two peaks P0, P1 are included in the color difference subrange of the boundary value a1 to boundary value a2, as shown in FIG. 12, the color-difference-subrange setup section 808 is operable to set a color difference value a11 at a midpoint between the peaks P0, P1, as a new boundary value a11.

The color-difference-subrange setup section 808 is also operable to calculate a color difference value a12 located at a midpoint between the peak P0 and a peak P2 on an opposite side of the peak P1 and adjacent to the peak P0, and set the color difference value a12 as a new boundary value a12. Then, the color-difference-subrange setup section 808 is operable to set a color difference subrange Y1 of the boundary value a12 to the boundary value a11, as a new color difference subrange. In this case, when a color difference value of the peak P0 is 10 degrees, the color-difference-subrange setup section 808 is operable to perform a search of the peak P2, for example, in the subrange of 300 to 360 degrees.

In the same manner as that for the color difference subrange Y1 illustrated in FIG. 12, the color-difference-subrange setup section 808 is operable to set the remaining new color difference subranges in such a manner that a color difference value located at a midpoint between each of the plurality of peaks included in the histogram covering the overall color difference range and an adjacent one of the remaining peaks serves as a boundary value between adjacent ones of the new color difference subranges.

Returning to FIG. 8, when it is determined in Step S9 that the number of peaks in the histogram covering the overall color difference range is greater than six (NO in Step S9), the color-difference-subrange setup section 808 sets new color difference subranges based on five of the plurality of peaks included in the histogram covering the overall color difference range, in the same manner as that in Step S10, i.e., in such a manner that a color difference value located at a midpoint between each of the five peaks and an adjacent one of the remaining four peaks serves as a boundary value between adjacent ones of the new color difference subranges (Step S11).

Then, the color-difference-subrange setup section 808 determines whether the number of peaks in a histogram covering the remaining color difference range other than the new color difference subranges (for the five peaks) set in Step S11 is six or less (Step S12). If the number is greater than six (NO in Step S12), Steps S11 and S12 will be repeated. Differently, when the number is six or less (YES in Step S12), the color-difference-subrange setup section 808 sets a plurality of new color difference subranges in such a manner that a color difference value located at a midpoint between each of the peaks included in the histogram covering the remaining color difference range other than the new color difference subranges set in Step S11 and an adjacent one of the remaining peaks serves as a boundary value between adjacent ones of the new color difference subranges (Step S13). Then, the routine advances to Step S14 to assign any one of the new color difference subranges to each of the character areas.

Then, in Step S14, the second color-difference-subrange assignment section 809 assigns any one of the new color difference subranges set by the color-difference-subrange setup section 808, to each of the character areas, for example, in such a manner as to allow an average of the color difference values of the pixels in each of the character areas to be included in the new color difference subrange which is to be assigned to the character area.

Then, in Step S15, the representative-color setup section 810 sets color information about a representative color of each of the character areas, using an average of color difference values (i.e., average color) included in the color difference subrange assigned to the character area, and stores information about the representative color, i.e., color information 66, in the intermediate-image-data temporary storage section 9. In this processing, the representative-color setup section 810 may be operable to create the color information 66 based on an average of color difference values HUE of pixels in each of the character areas in the color difference subrange assigned to the character area, or based on the average of the color difference values HUE and an average of color saturation values SAT of the pixels.

Through the above processing in Steps S1 to S15, an average color of pixels included in each of the character areas is set as a representative color of the character area under a condition that a color difference subrange of a histogram for each of the character areas is set to include only one peak. That is, color is reproduced in a more delicate manner as compared with the conventional technique configured to set a representative color using only a color difference value at a peak in the histogram 65. This makes it possible to achieve enhanced color reproducibility of a color character.

Although the color reproducibility of a color character can be enhanced in the above manner, it is also necessary to meet a need for allowing a user to intentionally change only a color of a character, for a reason of poor visibility or aesthetic quality of the character occurring, for example, when the character color is similar to a color of a background image. In view of this need, the scanner apparatus 1 is designed to allow a user to change a character color through the character-color changing processing section 80.

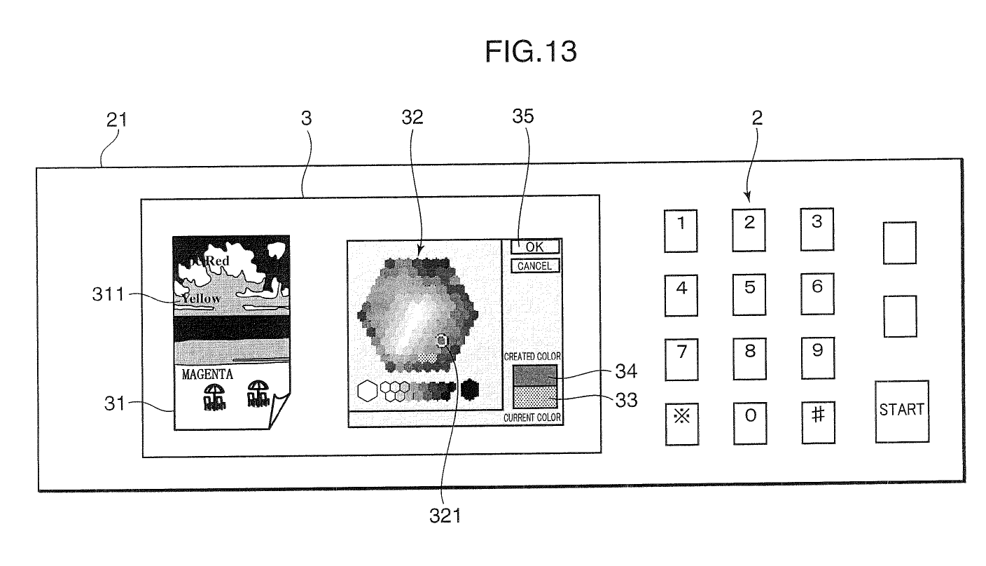

FIG. 13 is an explanatory diagram showing one example of a manual operation panel of the scanner apparatus 1. A manual operation panel 21 illustrated in FIG. 13 is provided with a manual operation section 2 having a plurality of operation key switches, such as a numeric keypad and a start key, and a touch panel 3.

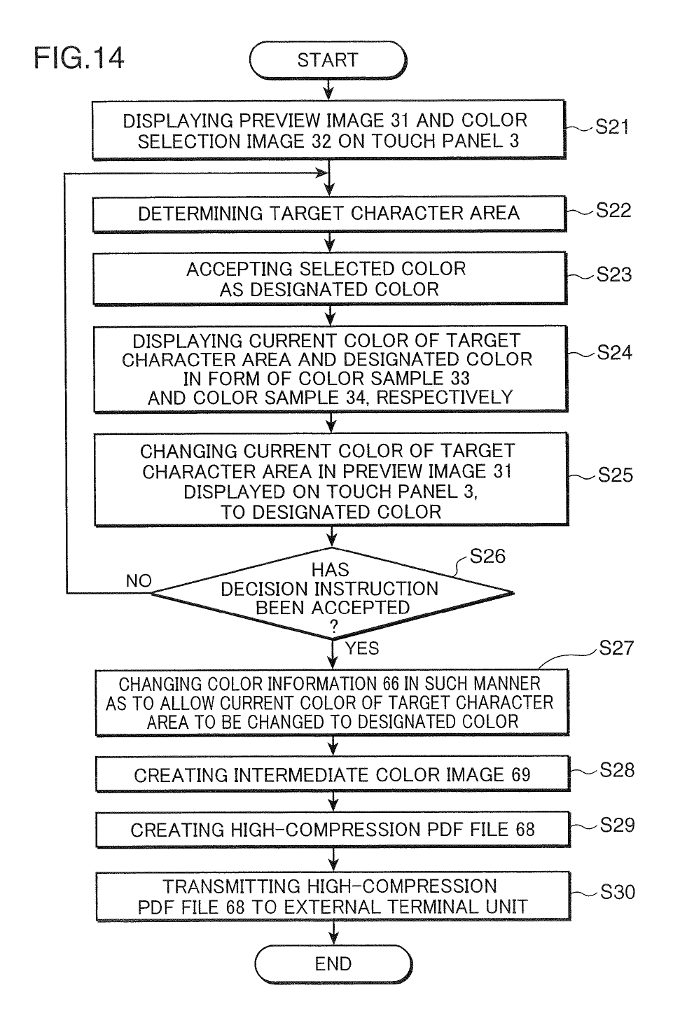

FIG. 14 is a flowchart showing one example of an operation of the character-color changing processing section 80 and associated sections. Based on the color image data 61 comprising the multivalued image data 63, the character image data 62 and the color information 66 which are stored in the intermediate-image-data temporary storage section 9, the first preview control section 81 causes the touch panel 3 to display a preview image 31 of the document.

The first preview control section 81 causes the touch panel 3 to further display a color selection image representing a plurality of colors for color selection (Step S21). For example, the color selection image 32 is composed of a combination of a plurality of regular hexagonal-shaped optional color blocks 321 each having a different color.

Then, when a user presses a specific one of the character areas, for example, a “Yellow” character area 311, in the preview image 31 displayed on the touch panel 3, the touch panel 3 outputs positional information about the specific character area 311. In this case, the positional information output from the touch panel 3 indicates one of the character areas extracted by the character-area extraction section 82. Thus, the color-designation acceptance section 83 determines that the specific character area 311 is a target character area (Step S22).

As above, through the simple operation of pressing the touch panel 3, the user can select a specific one of the character areas which has a color to be changed to a designated color. This provides enhanced operational performance.

Then, for example, when the user presses a specific one of the optional color blocks 321 in the color selection image 32 displayed on the touch panel 3, the touch panel 3 outputs positional information about the specific color block 321. Thus, based on the positional information output from the touch panel 3, the color-designation acceptance section 83 accepts a color of the specific color block 321, as a designated color (Step S23).

As above, through the simple operation of pressing the touch panel 3, the user can select a specific one of the optional colors which is to be set in the specific character area. This provides enhanced operational performance.

Then, the color-sample display control section 86 causes the touch panel 3 to display a current color of the character area selected as the target character area by the color-designation acceptance section 83, in the form of a color-sample image 33. The color-sample display control section 86 causes the touch panel 3 to further display the optional color accepted as the designated color by the color-designation acceptance section 83, in the form of a color-sample image 34 which is arranged side by side in a comparable manner with respect to the color-sample image 33 (Step S24).

Thus, the user can check the current color and the optional color selected as the designated color while comparing therebetween. This makes it possible to facilitate changing a color tone in a delicate manner.

Then, the second preview control section 85 changes the current color of the target character area in the preview image displayed on the touch panel 3, to the designated color accepted by the color-designation acceptance section 83 (Step S25). Thus, the user can check the preview image after changing the current color of the target character area to the designated color, under a condition that the character areas are superimposed on the background image. That is, the preview image 31 allows the user to check, for example, whether visibility of characters is improved in view of a relationship between respective colors of the background image and each of the character areas, or whether an image can be obtained with aesthetic quality just as intended by the user.

Subsequently, the decision-instruction acceptance section 87 causes the touch panel 3 to display a decision button 35. Then, in response to pressing the decision button 35, the touch panel 3 outputs positional information about the decision button 35. According to the positional information, the decision-instruction acceptance section 87 accepts a decision instruction indicative of a decision to set the character area selected as the target character area by the color-designation acceptance section 83, and the optional color accepted as the designated color by the color-designation acceptance section 8 (YES in Step S26).

Then, in response to acceptance of the decision instruction by the decision-instruction acceptance section 87, the color-change processing section 84 changes the color information 66 stored in the intermediate-image-data temporary storage section 9 in such a manner as to allow the current color of the character area selected as the target character area by the color-designation acceptance section 83, to be changed to the optional color accepted as the designated color by the color-designation acceptance section 83 (Step S27).

Through the above processing of Steps S21 to S27, a color of each of the character areas can be set just as intended by a user.

Then, the character compression section 812 compresses the character image data 62 stored in the intermediate-image-data temporary storage section 9 to create compressed character image data 67, for example, using an MMR scheme, and stores the compressed character image data 67 in the intermediate-image-data temporary storage section 9. In the above manner, intermediate image data 69 comprising the color information 66, the compressed character image data 67 and the compressed image data 64 is created, and stored in the intermediate-image-data temporary storage section 9 (Step 28).

Then, the transmit-image-file creation section 10 combines the color information 66, the compressed character image data 67 and the compressed image data 64 which are stored in the intermediate-image-data temporary storage section 9, together, to create an electronic file, such as a high-compression PDF file 88 or an XPS file, and stores the electronic file in the transmit-file temporary storage section 11 (Step S29). For example, in the high-compression PDF file 88, the color information 66 and the compressed character image data 67 are combined as mask information so as to superimpose a character image represented by the compressed character image data 67 on a background image represented by the compressed image data 64, and set a color of the character image to a representative color defined by the color information 66.

Then, the transmitter section 12 transmits the electronic file stored in the transmit-file temporary storage section 11, such as the high-compression PDF file 68, to an external terminal unit, such as a personal computer (Step S30). This makes it possible to reduce a data volume of the high-compression PDF file 68 to be transmitted to the external terminal unit, while minimizing deterioration in image quality of the character areas, and facilitate setting colors of the character areas just as intended by a user.

### Second Embodiment

A scanner apparatus la according to a second embodiment of the present invention will be described below. The scanner apparatus la is different from the scanner apparatus 1 in respective operations of a first preview control section 81a, a color-designation acceptance section 83a and a color-change processing section 84a in a character-color changing processing section 80a illustrated in FIG. 4.

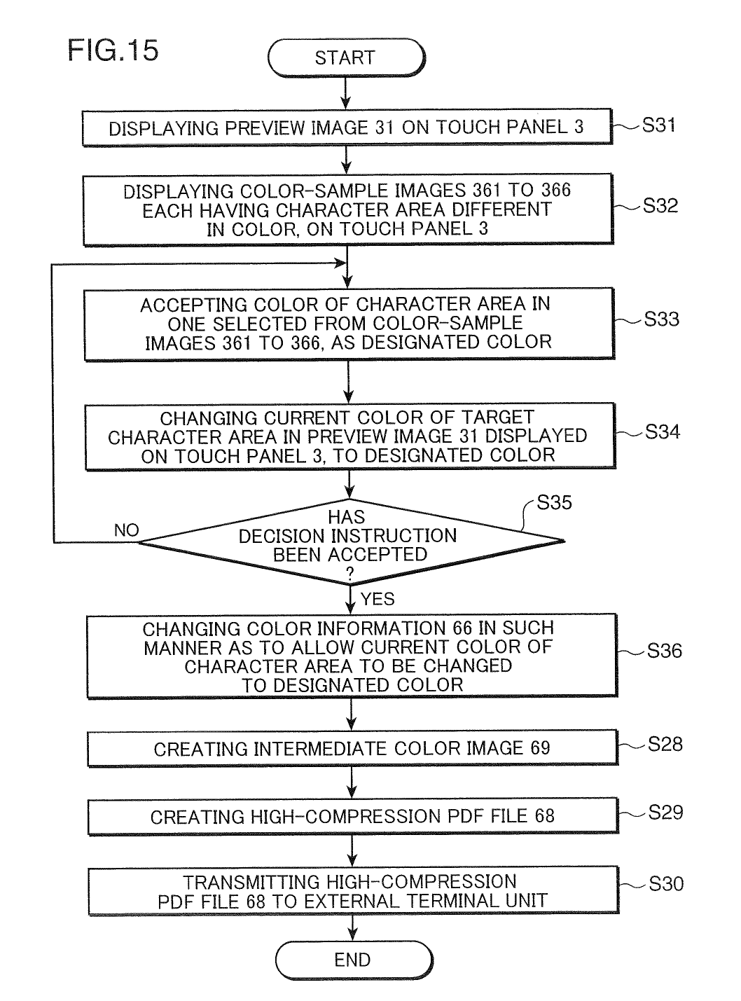

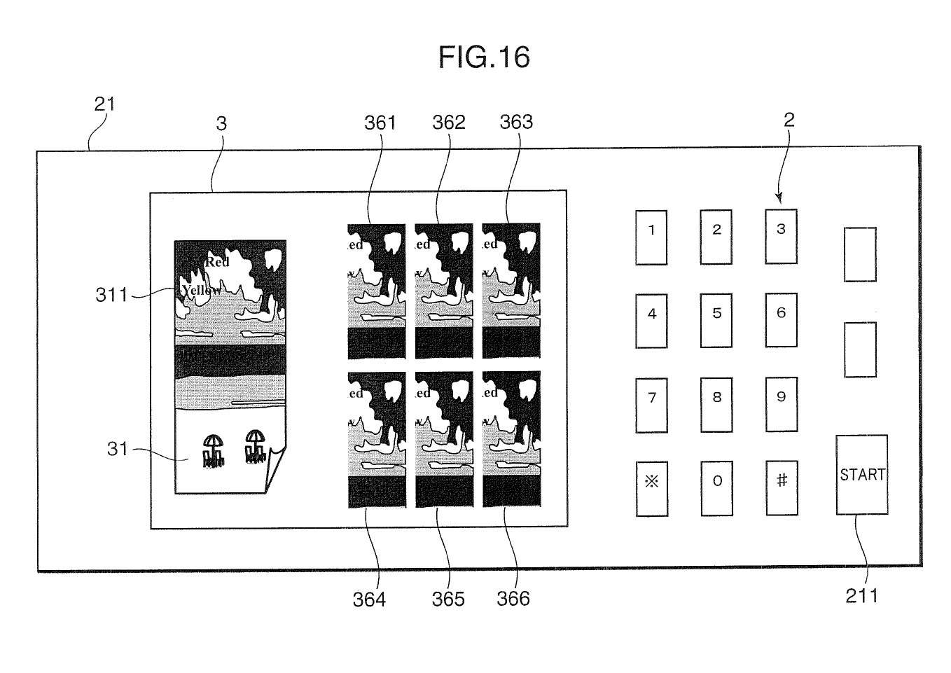

FIG. 15 is a flowchart showing one example of an operation of the character-color changing processing section 80a and associated sections in the scanner apparatus 1a according to the second embodiment. FIG. 16 is a schematic diagram for explaining an operation of the character-color changing processing section 80a. Based on the color image data 61 comprising the multivalued image data 63, the character image data 62 and the color information 66 which are stored in the intermediate-image-data temporary storage section 9, the first preview control section 81a causes the touch panel 3 to display a preview image 31 of the document (Step S31).

The first preview control section 81a causes the touch panel 3 to further display a plurality of color-sample images (e.g., six color-sample images 361 to 366) created based on at least a portion of the preview image 31, for example, based on an upper right one of four images obtained by dividing the preview image 31 in the form of a two-by-two matrix, in such a manner that a plurality of colors different from that of each of the character areas extracted by the character-area extraction section 82 set in respective corresponding character areas in the plurality of color-sample images (Step S32). For example, the first preview control section 81a is operable to create image data about the color-sample images 361 to 366 by changing a color saturation (or hue) of each of the character areas in the preview image 31 by a given value, e.g., by 10 (or 10 degrees), and cause the touch panel 3 to display the color-sample images 361 to 366.

In this case, color saturations (or hue) of the respective character areas in the color-sample images 361 to 366 are preferably set such that some of the color saturations (or hue) increase and the remaining color saturations (or hue) decrease, with respect to the color saturation (or hue) of the corresponding character area in the preview image 31. For example, color saturations (or hue) of the respective character areas in the color-sample images 361, 362, 363 are set at respective values obtained by adding 10 (or 10 degrees), 20 (or 20 degrees) and 30 (or 30 degrees) to the color saturations (or hue) of the corresponding character area in the preview image 31, and color saturations (or hue) of the respective character areas in the color-sample images 364, 365, 366 are set at respective values obtained by subtracting 10 (or 10 degrees), 20 (or 20 degrees) and 30 (or 30 degrees) from the color saturations (or hue) of the corresponding character area in the preview image 31.

Then, when a user presses a specific one of the color-sample images 361 to 366 displayed on the touch panel 3, for example, the color-sample image 361, the touch panel 3 outputs positional information about the color-sample image 361. Thus, based on the positional information output from the touch panel 3, the color-designation acceptance section 83a accepts a color of each character area in the color-sample image 361, as a designated color (Step S33).

In this manner, a user can select a desired character color while checking an image to be obtained by changing a color of each of the character areas in the preview image 31, based on the color-sample images 361 to 366 each having the character areas superimposed on the background image. This makes it easy to set a color having enhanced visibility as a character color in cases where the character color is similar to a color of the background image, or to select a color capable of obtaining an intended effect as a result of changing the character color, while checking a total aesthetic quality including the background image.

Then, the second preview control section 85 changes the current color of each of the character areas in the preview image displayed on the touch panel 3, to the designated color accepted by the color-designation acceptance section 83a (Step S34). Thus, the user can check the entire image after changing the current color of each of the character areas to the designated color, under a condition that the character areas are superimposed on the background image. That is, the preview image 31 allows the user to check, for example, whether visibility of characters is improved in view of a relationship between respective colors of the background image and each of the character areas, or whether an image can be obtained with aesthetic quality just as intended by the user.

Subsequently, the decision-instruction acceptance section 87a determines whether a start key 211 is pressed. When the start key 211 is pressed, the decision-instruction acceptance section 87a accepts a decision instruction indicative of a decision to set the color accepted as the designated color by the color-designation acceptance section 83a (YES in Step S35).

Then, in response to acceptance of the decision instruction by the decision-instruction acceptance section 87a, the color-change processing section 84a changes the color information 66 stored in the intermediate-image-data temporary storage section 9 in such a manner as to allow the current color of each of the character areas to be changed to the color accepted as the designated color by the color-designation acceptance section 83a (Step S36).

Subsequent processing in Steps S28 to S30 is the same as that in the scanner apparatus 1, and its description will be omitted.

### Third Embodiment

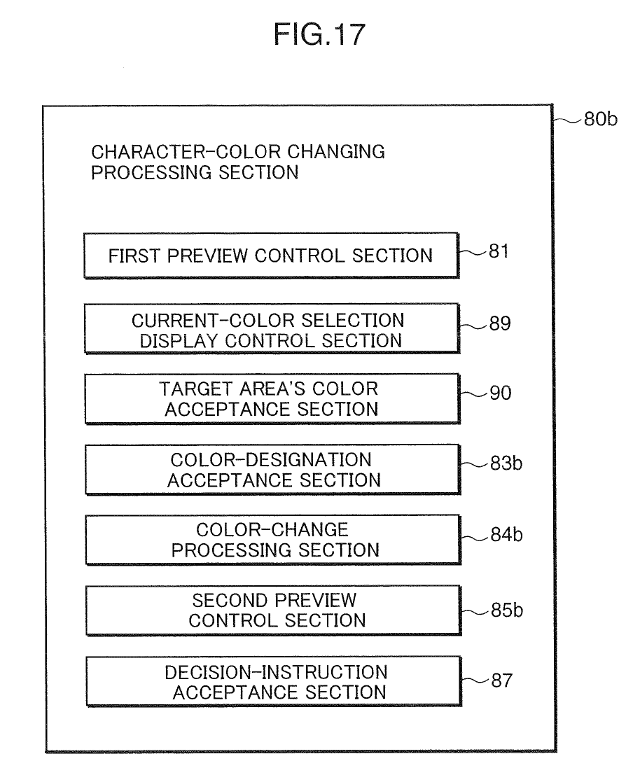

A scanner apparatus 1b according to a third embodiment of the present invention will be described below. The scanner apparatus 1b illustrated in FIG. 1 is different from the scanner apparatus 1 in the configuration of a character-color changing processing section 80b. FIG. 17 is a block diagram showing one example of the configuration of the character-color changing processing section 80b. Specifically, the scanner apparatus 1b illustrated in FIG. 1 is different from the scanner apparatus 1 in that the character-color changing processing section 80b further includes a current-color selection display control section 89 and a target area's color acceptance section 90, and in respective operations of a color-designation acceptance section 83b, a color-change processing section 84b and a second preview control section 85b.

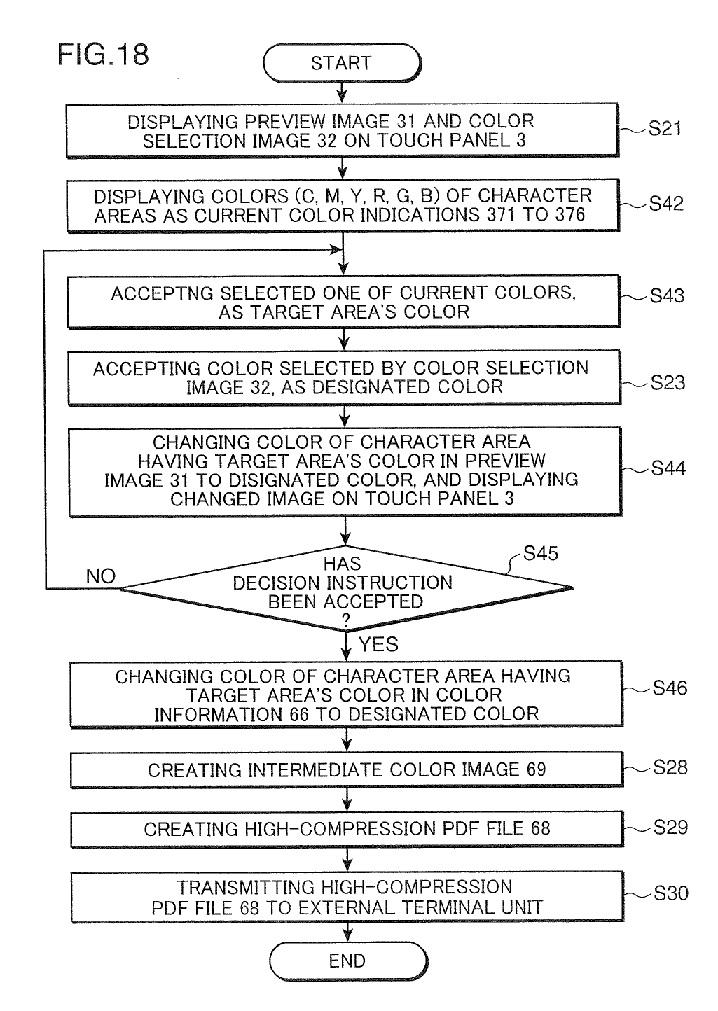

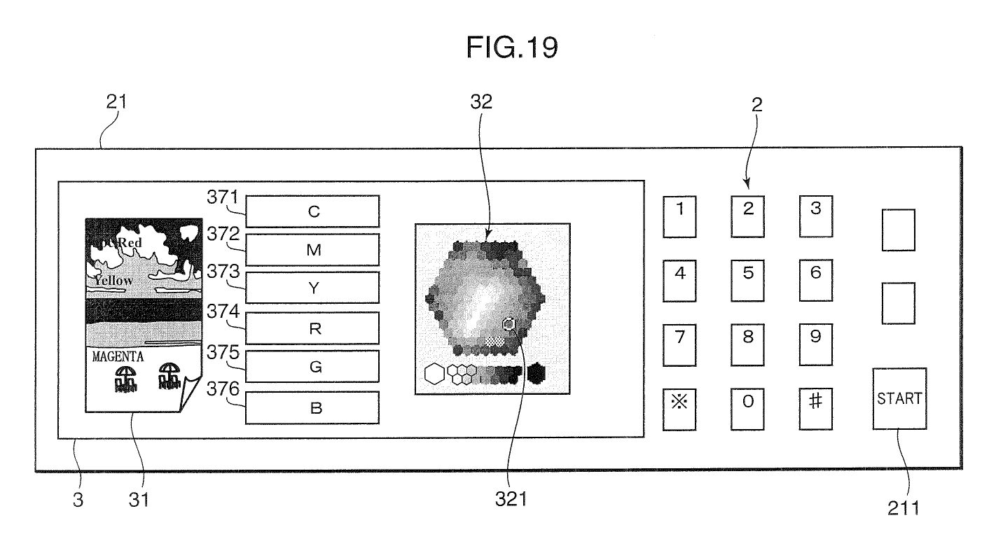

FIG. 18 is a flowchart showing one example of the operation of the character-color changing processing section 80b and associated sections, and FIG. 19 is a schematic diagram for explaining an operation of the character-color changing processing section 80b. Based on the color image data 61 comprising the multivalued image data 63, the character image data 62 and the color information 66 which are stored in the intermediate-image-data temporary storage section 9, the first preview control section 81 causes the touch panel 3 to display a preview image 31 of the document. The first preview control section 81 further causes the touch panel 3 to display a color selection image 32 representing a plurality of colors for color selection (Step S21).

Then, the current-color selection indicator control section 89 causes the touch panel 3 to display a plurality of colors assigned to respective ones of a plurality of character areas, e.g., six colors consisting of C (cyan), M (magenta), Y (yellow), R (red), G (green) and B (blue) which are assigned to respective ones of six character areas, as six current color indicators 371, 372, 373, 374, 375 each indicating an optional color (Step S42).

Then, when a user presses one (e.g., the current color indicator 374) of the current color indicators 371, 372, 373, 374, 375 displayed on the touch panel 3, the touch panel 3 outputs positional information about the current color indicator 374. Thus, based on the positional information output from the touch panel 3, the target area's color acceptance section 90 accepts the color of the current color indicator 374 as a target area's color, i.e., a current color of a target one of the character areas (Step S43).

Then, for example, when the user presses a specific one of a plurality of optional color blocks 321 in a color selection image 32 displayed on the touch panel 3, the touch panel 3 outputs positional information about the specific color block 321. Thus, based on the positional information output from the touch panel 3, the color-designation acceptance section 83b accepts a color of the specific color block 321, as a designated color (Step S23).

Then, the second preview control section 85b changes the color of the character area having the target area's color (i.e., the color of the current color indicator 374) accepted by the target area's color acceptance section 90, in the preview image displayed on the touch panel 3, to the designated color accepted by the color-designation acceptance section 83b. Thus, the user can check the image after changing the current color of the target character area to the designated color, under a condition that the character areas are superimposed on the background image. That is, the preview image 31 allows the user to check, for example, whether visibility of characters is improved in view of a relationship between respective colors of the background image and each of the character areas, or whether an image can be obtained with aesthetic quality just as intended by the user.

Subsequently, the decision-instruction acceptance section 87 determines whether the start key 211 is pressed. When the start key 211 is pressed, the decision-instruction acceptance section 87 accepts a decision instruction indicative of a decision to set the target area's color accepted by the target area's color acceptance section 90, and the designated color accepted by the color-designation acceptance section 83b (YES in Step S45).

Then, in response to acceptance of the decision instruction by the decision-instruction acceptance section 87, the color-change processing section 84b changes the color information 66 stored in the intermediate-image-data temporary storage section 9 in such a manner as to allow the color of the character area having the target area's color accepted by the target area's color acceptance section 90 to be changed to the color accepted as the designated color by the color-designation acceptance section 83b (Step S46).

Through the above processing in Steps S21 to S46, a color of each of the character areas can be set just as intended by a user.

Subsequent processing in Steps S28 to S30 is the same as that in the scanner apparatus 1, and its description will be omitted.

As mentioned above, an image processing apparatus according to one aspect of the present invention comprises: a display section adapted to display a color image; a storage section adapted to store therein color image data; a first preview control section operable to cause the display section to display a color image based on the color image data stored in the storage section, in the form of a preview image; a character-area extraction section operable to extract a character area from the color image data stored in the storage section; a color-designation acceptance section operable to accept a setting of a designated color which is a color to be newly set in the character area extracted by the character-area extraction section; a second preview control section operable to change a color of the character area extracted by the character-area extraction section and included in the preview image, to the designated color accepted by the color-designation acceptance section, and cause the display section to display the changed preview image; a decision-instruction acceptance section operable to accept a decision instruction indicative of a decision to set the designated color; and a color-change processing section operable, in response to acceptance of the decision instruction by the decision-instruction acceptance section, to change color information representing a color of the color image data stored in the storage section, in such a manner as to allow the color of the character area extracted by the character-area extraction section to be changed to the designated color accepted by the color-designation acceptance section.

In the image processing apparatus of the present invention, the first preview control section causes the display section to display a color image based on the color image data stored in the storage section, in the form of a preview image. This allows a user to figure out a color tone of the color image data stored in the storage section. Then, the character-area extraction section extracts a character area from the color image data stored in the storage section, and the color-designation acceptance section accepts a setting of a designated color which is a color to be newly set in the character area. Then, the second preview control section changes a color of the character area and included in the preview image, to the designated color, and causes the display section to display the changed preview image.

In response to acceptance of the decision instruction by the decision-instruction acceptance section, the color-change processing section changes color information representing a color of the color image data stored in the storage section, in such a manner as to allow the color of the character area to be changed to the designated color. Thus, a user can set a new color to the character area, while checking the preview image to determine whether an intended image will be obtained. This makes it possible to allow a user to set a color of the character area in the color image data just as intended.

In the image processing apparatus of the present invention, the display section preferably includes a touch panel which is adapted, in response to an operation of pressing a certain position of a display screen thereof on which the color image is displayed, to output positional information representing the pressed position. In this case, the first preview control section is operable to cause the display section to further display a plurality of optional colors each allowed to be newly set in the character area extracted by the character-area extraction section, and the color-designation acceptance section is operable, when the positional information output from the display section indicates the character area extracted by the character-area extraction section, to set the character area as a target character area, and, when the positional information output from the display section indicates a specific one of the plurality of optional colors, to accept the specific color as a designated color to be newly set in the target character area. Further, the color-change processing section is operable to change a color of the character area set as the target character area by the color-designation acceptance section, to the specific color accepted as the designated color by the color-designation acceptance section.

According to this feature, the first preview control section causes the touch panel included in the display section to further display a plurality of optional colors each allowed to be newly set in the character area. Then, when the positional information output from the touch panel included in the display section indicates the character area, the color-designation acceptance section sets the character area as a target character area. Thus, the user can set a target character area through the operation of pressing a specific character to be changed in color, in the preview image. This provides enhanced operational performance.

Then, when the positional information output from the display section indicates a specific one of the plurality of optional colors, the color-designation acceptance section accepts the specific color as a designated color to be newly set in the target character area. Thus, the user can set the designated color through the operation of pressing a specific one of the plurality of optional colors displayed on the touch panel. This provides enhanced operational performance.

Then, the color-change processing section changes a color of the character area set as the target character area by the color-designation acceptance section, to the specific color accepted as the designated color by the color-designation acceptance section. This makes it possible to facilitate an operation of setting a color of the character area in the color image data, as intended by a user.

Preferably, the above image processing apparatus further includes a color-sample display control section operable to cause the display section to display the color of the character area set as the target character area by the color-designation acceptance section and the specific color accepted as the designated color by the color-designation acceptance section, in a side-by-side arrangement.

According to this feature, the color-sample display control section causes the display section to display the color of the character area set as the target character area by the color-designation acceptance section and the specific color accepted as the designated color by the color-designation acceptance section, in a side-by-side arrangement. Thus, the user can check a pre-change color and a post-change color in a comparable manner. This makes it possible to facilitate setting a color tone in a delicate manner.

Preferably, in the image processing apparatus of the present invention, the first preview control section is operable to cause the display section to further display a plurality of color-sample images created based on at least a portion of the preview image in such a manner that respective character areas of the plurality of color-sample images are set to have a plurality of colors different from one another at respective portions corresponding to the character area extracted by the character-area extraction section, and the color-designation acceptance section is operable to accept a selection instruction indicative of selecting one of the plurality of color-sample images, and set the color of the character area in the selected color-sample image indicated by the selection instruction as the designated color.

According to this feature, the first preview control section causes the display section to further display a plurality of color-sample images created based on at least a portion of the preview image in such a manner that respective character areas of said plurality of color-sample images are set to have a plurality of colors different from one another at respective portions corresponding to the character area. Then, the color-designation acceptance section accepts a selection instruction indicative of selecting one of the plurality of color-sample images, and set the color of the character area in the selected color-sample image indicated by the selection instruction as the designated color.

Thus, the user can select a desired character color while checking an image to be obtained by changing a color of the character area in the preview image, based on the plurality of color-sample images each having the character area superimposed on the background image. This makes it easy to set a color having enhanced visibility as a character color in cases where the character color is similar to a color of the background image, or to set a color capable of obtaining an intended effect as a result of changing the character color, while checking a total aesthetic quality including the background image.

The image processing apparatus of the present invention may further include a current-color selection display control section operable to cause the display section to display respective colors of a plurality of character areas extracted by the character-area extraction section, in a selectable manner, and a target area's color acceptance section operable to accept a selection instruction indicating that one of the colors displayed on the display section by the current-color selection display control section is selected as a current color of a target one of the extracted character areas, wherein the color-change processing section is operable to change the color image data stored in the storage section, in such a manner as to allow the color of the target character area having a color which is selected from the plurality of character areas extracted by the character-area extraction section according to the selection instruction accepted by the target area's color acceptance section, to be changed to the designated color accepted by the color-designation acceptance section.

According to this feature, the current-color selection display control section causes the display section to display respective colors of a plurality of character areas extracted by the character-area extraction section, in a selectable manner. Then, the target area's color acceptance section accepts a selection instruction indicating that one of the colors displayed on the display section by the current-color selection display control section is selected as a current color of a target one of the extracted character areas. Then, the color-change processing section changes the color image data stored in the storage section, in such a manner as to allow the color of the target character area having a color which is selected from the plurality of character areas extracted by the character-area extraction section according to the selection instruction accepted by the target area's color acceptance section, to be changed to the designated color accepted by the color-designation acceptance section. Thus, through the operation of selecting a target one of the colors used in the plurality of character areas, the user can change a color of each of the character areas having the selected color, to the designated color.

Preferably, the image processing apparatus of the present invention further includes: a color-difference-value acquisition section operable to acquire information about respective color difference values of pixels in the character area extracted by the character-area extraction section; a color-saturation-value acquisition section operable to acquire information about respective color saturation values of the pixels in the character area extracted by the character-area extraction section; a color-difference-subrange storage section which stores a plurality of color difference subranges pre-defined by dividing an overall color difference range of zero degree to 360 degree into a plurality of subranges; a chromatic-region determination section operable, when the information about the color saturation values of the pixels in the character area acquired by the color-saturation-value acquisition section fails to satisfy a preset determination condition for determining whether a character area has a chromatic color, to determine the character area as a gray region, and, when the information about the color saturation values of the pixels in the character area satisfies the determination condition, to determine the character area as a chromatic region; a first color-difference-subrange assignment section operable, based on the information about the pixel color difference values acquired by the color-difference-value acquisition section, to assign any one of the plurality of color difference subranges stored in the color-difference-subrange storage section, to the character area determined as the chromatic region by the chromatic-region determination section; and a representative-color setup section operable to set color information about a representative color of the character area determined as the chromatic region by the chromatic-region determination section, using an average of the pixel color difference values acquired by the color-difference-value acquisition section and included in the color difference subrange assigned to the character area, wherein the first preview control section is operable to cause the display section to display the character area extracted from the color image data stored in the storage section and determined as the chromatic region by the chromatic-region determination section, with a color based on the color information set by the representative-color setup section.

According to this feature, the character-area extraction section extracts a character area from color image data. Then, the color-difference-value acquisition section acquires information about respective color difference values of pixels in the character area, and the color-saturation-value acquisition section acquires information about respective color saturation values of the pixels in the character area. The color-difference-subrange storage section stores a plurality of color difference subranges which are pre-defined by dividing an overall color difference range of zero degree to 360 degree into a plurality of subranges. Then, the chromatic-region determination section determines the character area as a gray region operable, when the information about the color saturation values of the pixels in the character area acquired by the color-saturation-value acquisition section fails to satisfy a preset determination condition for determining whether a character area has a chromatic color, or determines the character area as a chromatic region, when the information about the color saturation values of the pixels in the character area satisfies the determination condition. Based on the information about the color difference values of the pixels in the character area determined as the chromatic region, the first color-difference-subrange assignment section assigns any one of the plurality of color difference subranges stored in the color-difference-subrange storage section, to the character area. Then, the representative-color setup section sets color information about a representative color of the character area determined as the chromatic region, using an average of the pixel color difference values included in the color difference subrange assigned to the character area.

In view of a general trend, it is often the case that a primary color is used as a character color. That is, the number of colors to be frequently used as character colors is small. From this point of view, the plurality of color difference subranges can be pre-set to include respective ones of a plurality of color difference values to be frequently used as character colors, and stored in the color-difference-subrange storage section. Then, based on information about respective color difference values of pixels in each of a plurality of character areas, the first color-difference-subrange assignment section assigns any one of the plurality of color difference ranges to each of the character areas. This makes it possible to facilitate assigning to each of the character areas one of the color difference subranges which is close to a color of the character area.

In addition, the representative-color setup section sets color information about a representative color of each of the character areas determined as the chromatic region, using an average of the pixel color difference values included in the color difference subrange assigned to the character area. Thus, differently from the conventional technique configured to set a representative color of a character area using a color difference value exhibiting a peak in a histogram, a representative color of the character area is acquired in consideration with a wider range of color difference values in addition to that at a peak in a histogram covering a color difference subrange with a certain width. This makes it possible to achieve enhanced color reproducibility of a color character.

Furthermore, based on the color information set by the representative-color setup section, i.e., color information having enhanced color reproducibility, in the color image data stored in the storage section, the first preview control section causes the display section to display a color of each of the character areas determined as the chromatic region by the chromatic-region determination section. This allows the user to check a color tone of the color image based on the preview image having enhanced color reproducibility.

Preferably, the image processing apparatus of the present invention further includes: an image read section operable to read the color image data from a document; a binarized-data creation section operable to binarize image data about the character area extracted by the character-area extraction section, so as to create character image data; a character compression section operable to compress the character image data created by the binarized-data creation section, so as to create compressed character image data; an image compression section operable to compress image data about the remaining area other than the character area in the color image data, to create compressed image data; a combined-data creation section operable to combine the color information after being changed by the color-change processing section, the compressed character image data created by the character compression section, and the compressed image data created by the image compression section, together, so as to create combined data; and a communication section operable to transmit the combined data created by the combined-data creation section, to an external terminal unit.

According to this feature, the image read section reads color image data from a document. Then, image data about a character area extracted by the character-area extraction section is binarized to create character image data. The binarized character image data is compressed to create compressed character image data. The remaining image data other than the character area in the color image data read from the document is compressed to create compressed image data. Then, the color information of the character area, the compressed character image data and the compressed image data are combined together to create combined data. This makes it possible to facilitate reduction in size of the combined data based on an increase in data compression ratio while minimizing deterioration in image quality of the character area, and facilitate reduction in communication load during transmission of the combined data to the external terminal unit.

This application is based on Japanese Patent application serial No. 2007-071059 filed in Japan Patent Office on Mar. 19, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image processing apparatus comprising:
a display section adapted to display a color image;
a storage section adapted to store therein color image data;
a first preview control section operable to cause said display section to display a color image based on the color image data stored in said storage section, in the form of a preview image;
a character-area extraction section operable to extract a character area from the color image data stored in said storage section;
a color-designation acceptance section operable to accept a setting of a designated color which is a color to be newly set in the character area extracted by said character-area extraction section;
a second preview control section operable to change a color of the character area extracted by said character-area extraction section and included in said preview image, to the designated color accepted by said color-designation acceptance section, and cause said display section to display said changed preview image;
a decision-instruction acceptance section operable to accept a decision instruction indicative of a decision to set the designated color; and
a color-change processing section operable, in response to acceptance of said decision instruction by said decision-instruction acceptance section, to change color information representing a color of the color image data stored in said storage section, in such a manner as to allow the color of the character area extracted by said character-area extraction section to be changed to the designated color accepted by said color-designation acceptance section.

2. The image processing apparatus as defined in claim 1, wherein:
said display section includes a touch panel adapted, in response to an operation of pressing a certain position of a display screen thereof on which said color image is displayed, to output positional information representing said pressed position;
said first preview control section is operable to cause said display section to further display a plurality of optional colors each allowed to be newly set in the character area extracted by said character-area extraction section;
said color-designation acceptance section is operable, when the positional information output from said display section indicates the character area extracted by said character-area extraction section, to set said character area as a target character area, and, when the positional information output from said display section indicates a specific one of said plurality of optional colors, to accept said specific color as a designated color to be newly set in said target character area; and
said color-change processing section is operable to change a color of the character area set as the target character area by said color-designation acceptance section, to said specific color accepted as the designated color by said color-designation acceptance section.

3. The image processing apparatus as defined in claim 2, which further includes a color-sample display control section operable to cause said display section to display the color of the character area set as the target character area by said color-designation acceptance section and the specific color accepted as the designated color by said color-designation acceptance section, in a side-by-side arrangement.

4. The image processing apparatus as defined in claim 1, wherein:
said first preview control section is operable to cause said display section to further display a plurality of color-sample images created based on at least a portion of said preview image in such a manner that respective character areas of said plurality of color-sample images are set to have a plurality of colors different from one another at respective portions corresponding to the character area extracted by said character-area extraction section; and
said color-designation acceptance section is operable to accept a selection instruction indicative of selecting one of said plurality of color-sample images, and set the color of the character area in said selected color-sample image indicated by said selection instruction as said designated color.

5. The image processing apparatus as defined in claim 1, which further includes:
a current-color selection display control section operable to cause said display section to display respective colors of a plurality of character areas extracted by said character-area extraction section, in a selectable manner; and
a target area's color acceptance section operable to accept a selection instruction indicating that one of said colors displayed on said display section by said current-color selection display control section is selected as a current color of a target one of said extracted character areas,
wherein said color-change processing section is operable to change the color image data stored in said storage section, in such a manner as to allow the color of the target character area having a color which is selected from the plurality of character areas extracted by said character-area extraction section according to the selection instruction accepted by said target area's color acceptance section, to be changed to the designated color accepted by said color-designation acceptance section.

6. The image processing apparatus as defined in claim 1, which further includes:
a color-difference-value acquisition section operable to acquire information about respective color difference values of pixels in the character area extracted by said character-area extraction section;
a color-saturation-value acquisition section operable to acquire information about respective color saturation values of the pixels in the character area extracted by said character-area extraction section;
a color-difference-subrange storage section which stores a plurality of color difference subranges pre-defined by dividing an overall color difference range of zero degree to 360 degree into a plurality of subranges;
a chromatic-region determination section operable, when the information about the color saturation values of the pixels in the character area acquired by said color-saturation-value acquisition section fails to satisfy a preset determination condition for determining whether a character area has a chromatic color, to determine said character area as a gray region, and, when the information about the color saturation values of the pixels in said character area satisfies said determination condition, to determine said character area as a chromatic region;
a first color-difference-subrange assignment section operable, based on the information about the pixel color difference values acquired by said color-difference-value acquisition section, to assign any one of the plurality of color difference subranges stored in said color-difference-subrange storage section, to the character area determined as the chromatic region by said chromatic-region determination section; and
a representative-color setup section operable to set color information about a representative color of the character area determined as the chromatic region by said chromatic-region determination section, using an average of the pixel color difference values acquired by said color-difference-value acquisition section and included in the color difference subrange assigned to said character area,
wherein said first preview control section is operable to cause said display section to display the character area extracted from the color image data stored in said storage section and determined as the chromatic region by said chromatic-region determination section, with a color based on the color information set by said representative-color setup section.

7. The image processing apparatus as defined in claim 1, which further includes:
an image read section operable to read the color image data from a document;
a binarized-data creation section operable to binarize image data about the character area extracted by said character-area extraction section, so as to create character image data;
a character compression section operable to compress the character image data created by said binarized-data creation section, so as to create compressed character image data;
an image compression section operable to compress image data about the remaining area other than the character area in said color image data, to create compressed image data;
a combined-data creation section operable to combine the color information after being changed by said color-change processing section, the compressed character image data created by said character compression section, and the compressed image data created by said image compression section, together, so as to create combined data; and
a communication section operable to transmit the combined data created by said combined-data creation section, to an external terminal unit.
